(19) United States
(12) Patent Application Publication
(10) Pub. No.: US 2016/0302411 A1
(43) Pub. Date: Oct. 20, 2016

(54) BLENDS AND THEIR USE IN THE CONTROLLING AND/OR TRAPPING OF MOTHS

(71) Applicant: BIOFORSK (THE NORWEGIAN INSTITUTE FOR AGRICULTURAL AND ENVIRONMENTAL RESEARCH), As (NO)

(72) Inventor: Gunda Jasmin THOMING, As (NO)

(73) Assignee: BIOFORSK (THE NORWEGIAN INSTITUTE FOR AGRICULTURAL AND ENVIRONMENTAL RESEARCH), As (NO)

(21) Appl. No.: 14/778,256

(22) PCT Filed: Mar. 19, 2014
(86) PCT No.: PCT/EP2014/055480

§ 371 Date: Sep. 18, 2015

(30) Foreign Application Priority Data
Mar. 20, 2013 (GB) 1305118.0

(51) Int. Cl. A01N 37/06; A01N 31/02; A01N 27/00

(52) U.S. Cl. CPC A01N 37/06; A01N 27/00; A01N 31/02

(57) ABSTRACT

The present invention relates to compositions for use in attracting Tortix moths and insect traps comprising such compositions. The invention further relates to methods of using such compositions and kits comprising the components of the compositions.

The present invention relates to compositions for use in attracting Tortix moths and insect traps comprising such compositions. The invention further relates to methods of using such compositions and kits comprising the components of the compositions.

The pea moth Cydia nigricana Fabricius (Lepidoptera: Tortricidae) is an important pest in pea production, Pisum sativum L. (Fabaceae), in Europe. The larvae of the pea moth feed on pea seeds and cause major crop losses and quality reduction in grain and green peas.

Today, pea moth control relies on insecticide treatments, often combined with preventive measures like field rotation, early sowings and threshold distances between pea fields. However, for most of its life cycle C. nigricana is protected from insecticide sprays in the soil or in the pods. Furthermore, mated female moths often migrate into the crop area from long distances away. Consequently, pea moth management is getting more and more difficult, and the development of efficient alternative control methods is therefore needed.

It is known that many flowering plants attract insects and that this is due to the detection of volatile phytochemicals by these insects. However, plants naturally release one hundred or more volatile compounds. The current hypothesis is that insects are attracted to the host plant by only a small number of key volatile compounds in a species-specific blend and ratio.

However, there are large amounts of variation in the volatile compounds which are released by different plant species and cultivars, and at different phenological stages. In addition to blends of volatile compounds which actively attract insects, there are also blends which actively repel insects. All this adds to the complexity of the volatile phytochemicals that an insect has to deal with during the process of host plant location.

The inventors have recognised that, if a combination of volatile compounds could be identified which attract pea moths, then such a combination could be used to help to address the need to control this important insect pest. By analysing the odour profiles of the different phenological stages of pea plants and testing antennal and behavioural responses of the pea moth towards these volatile compounds, the inventors have now managed to identify a number of compositions which are capable of attracting pea moths to pea plants.

It is therefore an object of the present invention to provide a novel composition comprising a specific mixture of volatile compounds which is capable of attracting pea moths or other similar moths. Such compositions may be used in insect traps or other control tools in order to reduce the damage that such moths do to crops.

In one aspect, therefore, the invention provides a composition for attracting Tortrix moths, wherein the composition comprises:

(a) (E)-β-ocimene,
(b) (Z)-β-ocimene,
(c) 1-hexanol and
(d) (E)-2-hexen-1-ol.

Preferably, the composition additionally comprises one or more compounds selected from the group consisting of:

(e) (Z)-3-hexenal,
(f) (E)-2-hexenal,
(g) octanal,
(h) nonanal,
(i) (Z)-3-hexenol and
(j) (Z)-3-hexenyl acetate.

In a further aspect, the invention provides an insect trap comprising a composition of the invention.

In a further aspect, the invention provides a method of attracting, monitoring, disrupting, annihilating, trapping or controlling Tortrix moths, the method comprising providing a composition of the invention in an insect trap.

In yet a further aspect, the invention provides the use of a composition of the invention in attracting, monitoring, disrupting, annihilating, trapping or controlling Tortrix moths.

The invention relates to a composition for attracting Tortrix moths. Tortrix moths are from the family Tortricidae, in the order Lepidoptera. Preferably, the moth is of the genus Cydia. Most preferably, the moth is the pea moth, Cydia nigricana.

In some embodiments, the moth is a male moth. In other embodiments, the moth is a female moth. The female moth may be a virgin moth or be one which has mated.

The moth may be a young moth, e.g. 5-7 days old.

The larvae of Cydia nigricana feed on Pea, Lathyrus, Vicia, Phaseolus, Lupinus and Cytisus species. These larvae are therefore economically-important pests.

The term Pea includes Pisum ssp. (e.g. Pisum sativum) as well as other human and animal seeds from the Fabaceae family, such as the pigeon pea (Cajanus cajan) and the cowpea (Vigna unguiculata). Preferably the pea is Pisum sativum.

Lathyrus is a genus of flowering plant species known as sweet peas and vetchlings. The genus includes the garden sweet pea (Lathyrus odoratus) and the perennial everlasting pea (Lathyrus latifolius).

Other food species include L. sativus, L. cicera, L. ochrus, L. clymenum and L. tuberosus.

Vicia is a genus of about 140 species of flowering plants commonly known as vetches. It is in the legume family (Fabaceae). It includes the broad bean, Vicia faba, and Vicia sepium.

Phaseolus (Bean, Wild Bean) is a genus in the family Fabaceae of about fifty plant species, all native to the Americas. At least four of the species have been domesticated, including the common bean, P. vulgaris.

Lupinus, commonly known as lupin or lupine (North America), is a genus of flowering plants in the legume family (Fabaceae).

Cytisus is a genus of about 50 species of flowering plants in the family Fabaceae. It belongs to the subfamily Faboideae, and is one of several genera in the tribe Genisteae which are commonly called “brooms”.

In some embodiments, the composition of the invention comprises:

(a) (E)-β-ocimene,
(b) (Z)-β-ocimene,
(c) 1-hexanol and
(d) (E)-2-hexen-1-ol.

Preferably, the composition additionally comprises one or more compounds selected from the group consisting of:

(e) (Z)-3-hexenal,
(f) (E)-2-hexenal,
(g) octanal,
(h) nonanal,
(i) (Z)-3-hexenol and
(j) (Z)-3-hexenyl acetate.

In other embodiments, the composition additionally comprises one or more compounds selected from the group consisting of:

(f) (E)-2-hexenal,
(g) octanal,
(h) nonanal,
(i) (Z)-3-hexenol and
(j) (Z)-3-hexenyl acetate.

In other embodiments, the composition additionally comprises one or more compounds selected from the group consisting of sabinene, myrcene, linalool, caryophyllene, phenylacetaldehyde, citronellol and nerol.

CAS numbers for each of (a)-(j) are given in Table 1.

In some embodiments, the compositions of the invention consist essentially of components (a)-(d) and optionally one or more of components (e)-(j) or (f)-(j).

In other embodiments, the compositions of the invention comprise components (a)-(d) and optionally one or more of components (e)-(j) or (f)-(j) in the absence of any other kairomones.

In yet other embodiments, the compositions of the invention comprise components (a)-(d) and optionally one or more of components (e)-(j) or (f)-(j) in the absence of any other monoterpenes.

In some embodiments, the invention provides a composition comprising two, three or four of (a)-(d):

(a) (E)-β-ocimene,
(b) (Z)-β-ocimene,
(c) 1-hexanol
(d) (E)-2-hexen-1-ol,
and optionally one or more of (e)-(j):
(e) (Z)-3-hexenal,
(f) (E)-2-hexenal,
(g) octanal,
(h) nonanal,
(i) (Z)-3-hexenol
(j) (Z)-3-hexenyl acetate.

In other embodiments, the invention provides a composition comprising two, three or four of (a)-(j):

(a) (E)-β-ocimene,
(b) (Z)-β-ocimene,
(c) 1-hexanol,
(d) (E)-2-hexen-1-ol
(e) (Z)-3-hexenal,
(f) (E)-2-hexenal,
(g) octanal,
(h) nonanal,
(i) (Z)-3-hexenol,
(j) (Z)-3-hexenyl acetate.

In some embodiments, the composition of the invention comprises:

(a) (E)-β-ocimene,
(b) (Z)-β-ocimene,
(c) 1-hexanol,
(d) (E)-2-hexen-1-ol
(f) (E)-2-hexenal,
(g) octanal,
(h) nonanal,
(i) (Z)-3-hexenol, and
(j) (Z)-3-hexenyl acetate.

In other embodiments, the composition of the invention comprises:

(a) (E)-β-ocimene,
(b) (Z)-β-ocimene,
(c) 1-hexanol,
(d) (E)-2-hexen-1-ol
(e) (Z)-3-hexenal,
(f) (E)-2-hexenal,
(g) octanal,
(h) nonanal,
(i) (Z)-3-hexenol, and
(j) (Z)-3-hexenyl acetate.

Table 2 provides details of the preferred relative amounts of the components of the composition. Particularly preferred referred relative amounts are given in the column headed “Flowers only”. In this table, the percentage amounts of the compounds were calculated by dividing the peak area for that compound obtained from using a total ion chromatogram by the area of the internal standard, which was 500 ng heptyl acetate. This is an accepted method to quantify the relative amounts of volatile compounds in compositions.

Information may therefore be derived from Table 2 on the preferred relative amounts of the compounds (a)-(j) in the compositions of invention. For example, Table 2 shows that there was 0.030% (E)-2-hexenal and 0.002% octanal in the “Flowers only” column. From this, it may be determined that approximately 15 times more (E)-2-hexenal is present in the pea flower volatiles than octanal (in wt/wt). Two- or multi-way comparisons between the percentages given for any of components (a)-(j) may similarly be made; the ratios of such compounds form preferred embodiments of the composition of the invention.

The following preferred relative amounts may therefore be used to define preferred ratios of compounds (a)-(j) in the composition of the invention:

Preferably, (E)-β-ocimene is present in the composition in a relative amount of 0.3-0.8%, more preferably 0.4-0.7%, and even more preferably about 0.535%.
Preferably (Z)-β-ocimene is present in the composition in a relative amount of 0.03-0.10%, more preferably 0.05-0.09, and even more preferably about 0.068%.
Preferably 1-hexanol is present in the composition in a relative amount of 0.05-0.13%, more preferably 0.07-0.11%, even more preferably about 0.091%.
Preferably (E)-2-hexen-1-ol is present in the composition in a relative amount of 0.02-0.04%, more preferably 0.025-0.035%, even more preferably about 0.032%.
If present in the composition, (Z)-3-hexenal is preferably present in a relative amount of 0.001-0.400%, more preferably 0.1-0.3%, even more preferably about 0.155%
If present in the composition, (E)-2-hexenal is preferably present in a relative amount of 0.02-0.04%, more preferably 0.025-0.035%, even more preferably about 0.030%.
If present in the composition, octanal is preferably present in a relative amount of 0.0005-0.004%, more preferably 0.001-0.003%, even more preferably about 0.002%.
If present in the composition, nonanal is preferably present in a relative amount of 0.005-0.020%, more preferably 0.010-0.015%, even more preferably about 0.013%
If present in the composition, (Z)-3-hexenol is preferably present in a relative amount of 0.1-0.2%, more preferably 0.120%-0.170%, even more preferably about 0.145%.
If present in the composition, (Z)-3-hexenyl acetate is preferably present in a relative amount of 0.5-0.9%, more preferably 0.6%-0.8%, even more preferably about 0.705%.
Preferably, the ratio of (Z)-β-ocimene:(E)-β-ocimene is 1:7-9, more preferably about 1:8.

In some embodiments of the invention, the composition does not comprise a denatured alcohol.

The composition of the present invention may also, in addition or instead of one or more of the compounds listed above, comprise structurally-similar compounds having essentially the same structure and attractant characteristics as the compounds (a)-(j).

The expression “structurally similar compounds having essentially the same structure and attractant characteristics thereof” is meant to encompass compounds that compared with the listed compounds differ only by minor modifications of their structures, such as e.g. by introduction of substituents (e.g. methyl, ethyl groups, halogen groups) on the alkyl and alkenyl chains etc.

The composition of the present invention may additionally comprise other non-kairomone compounds which are useful for attracting Tortrix moths, such as e.g. pheromones. Pheromones are signal molecules typically produced by species belonging to the order Lepidoptera and which, upon release by the female insects, will attract males. Various pheromones of relevance to Tortrix moths will be well known to the skilled person, and which accordingly may be useful in combination with the composition of the present invention. Examples of pea moth pheromones which may be useful in combination with the composition of the present invention include (E,E)-8, 10-dodecadien-1-yl acetate; (E8E10-12AC). Other pea moth pheromone compounds include E10-12Ac ((E)-10-Dodecenyl acetate), E8E10-12OH ((E,E)-8,10-Dodecadien-1-ol) and Z8-12Ac ((Z)-8-Dodecenyl acetate). (See El-Sayed AM 2012. The Pherobase: Database of Insect Pheromones and Semiochemicals and http://www.pherobase.com for others.)

In addition, the composition of the present invention may optionally comprise one or more insecticides. These may be used to kill Tortrix moths which enter an insect trap of the invention. The skilled person will be aware of various natural and synthetic pesticides that may be used to kill Tortrix moths. A non-limiting list of insecticides useful for this purpose is pyrethroids, insect growth regulators and other contact-acting pesticides which affect adult Lepidoptera or their egg deposition.

Furthermore, the composition of the present invention may optionally comprise one or more additives which are useful in the formulation of a composition of the invention. Examples of such additives include emulsifiers, antioxidants, thickeners, fillers and solvents. Also compounds enabling controlled-release or sustained release of the compounds of the present composition may be useful as additives to the present invention. Examples of antioxidants include BHT (butylated hydroxytoluene).

The components of the present composition may be dissolved in any suitable carrier enabling the presentation of the components towards the relevant insects, i.e. enabling the attraction of Tortrix moths. Preferably, the carrier is a carrier which is odour-free, i.e. one which does not interfere with the compositions' ability to attract Tortrix moths.

According to one preferred embodiment, the compounds of the present composition are dissolved in mineral oil, such as liquid paraffin, e.g. the mineral oil having the CAS number 8042-47-5.

According to another embodiment of the present invention, the compounds of the present composition are present in a non-polar solvent, e.g. hexane.

The carrier may be a liquid or a solid.

In yet a further embodiment, the invention provides a kit comprising:

(a) (E)-β-ocimene,
(b) (Z)-β-ocimene,
(c) 1-hexanol and
(d) (E)-2-hexen-1-ol
for use as an insect attractant or for use in an insect trap.

Preferably, the kit additionally comprises one or more of:

(e) (Z)-3-hexenal,
(f) (E)-2-hexenal,
(g) octanal,
(h) nonanal,
(i) (Z)-3-hexenol and
(j) (Z)-3-hexenyl acetate.

When the invention is supplied as a kit, the different components of the composition may be packaged in separate containers and admixed prior to use.

In other embodiments, the kit may comprise one or more subsets of these components wherein the subsets of the components have been combined in a single container.

In particular, (a)-(d) may be present individually (e.g. in individual containers) in the kit or one or more of (a)-(d) may be combined. Similarly, one or more of (a)-(j) may be combined, when present, in the kit.

In particular, (a) and (b) may be combined (e.g. as a mixture of the isomers).

The kit may additionally comprise instructions for use as an insect attractant or for use in an insect trap. Preferably, the insect is a Tortrix moth (e.g. a pea moth).

The composition of the present invention may be used in insect traps for monitoring, annihilating, trapping and/or controlling of the Tortrix moth population.

Any insect trap useful for entrapment of Tortrix moths may be used.

The insect trap may additionally comprise means to kill moths. Such means include sticky areas of the trap, such as delta traps with sticky bottoms; and electric means, such as means to electrocute moths.

In insect traps which contain sticky materials, the sticky material is preferably protected from rain or watering.

The insect trap should preferably be constructed so as to avoid deterioration of the composition according to the present invention due to UV radiation. In words, the composition of the invention may be shaded from the sun in the trap.

Examples of traps that may be useful in this respect is the Tetra Trap provided by PheroNet AB, Lund, Sweden; the Isotrap (Model IT400) from CBC Europe Ltd., Milan, Italy; the Pherocon VI Delat trap or II B available from Trécé Inc., Adair, USA; and the Tetra pack traps as produced by Silvandersson Sweden, Knäred, Sweden.

The composition may be present in a cartridge or other replaceable module which is adapted to fit or be placed within the insect trap.

The insect trap device of the present invention is preferably located in a target area in which Tortrix moths are found. The area may be an area where the moths are breeding or over-wintering; and/or an area which is adjacent to or within an area planted with one or more Pea, Lathyrus, Vicia, Phaseolus, Lupinus or Cytisus species.

The composition and insect trap of the present invention may be used for monitoring, annihilating, disrupting, trapping and/or controlling of the Tortrix moth population.

The knowledge of the presence of and number of Tortrix moths during the growing season would enable the farmer to decide when to apply insect control measures to the crop. The monitoring of and the better control of the development of the Tortrix moth may thus result in reduced use of insect repellents and/or insecticides.

According to another aspect of the present invention, the invention provides a method of monitoring the presence of Tortrix moths in a location, the method comprising the steps:
(i) placing a composition or insect trap of the invention in the location; and
(ii) monitoring the number of Tortrix moths which are attracted to the composition or trap.

Also provided is a method of monitoring the presence of Tortrix moths in a location, the method comprising the steps:
(i) placing an insect trap of the invention in the location; and
(ii) monitoring the number of Tortrix moths which are caught in the insect trap.

Preferably, the step of monitoring comprises counting the number of moths trapped, optionally over a defined time interval.

The invention further provides the use of a composition or insect trap of the invention for monitoring the presence of Totrix moths in a location.

Preferably, the location is one which is inhabited or thought to be inhabited by the Tortrix moths.

The insect trap of the present invention is particularly useful in trapping of Tortrix moths within organically-grown farms where the use of insect repellents is not accepted. The insect trap of the present invention is also useful for trapping of Tortrix moths in private gardens.

The invention further provides a method of trapping and/or controlling Tortrix moths, the method comprising the steps:
(i) placing a composition or insect trap of the invention in a location which is inhabited or thought to be inhabited by the Tortrix moths.

The invention also provides the use of a composition or insect trap of the invention for trapping and/or controlling Tortrix moths.

According to another embodiment of this aspect, the present invention relates to the use of the composition or trap according to the present invention in the reduction of insecticides/pest repellents required to control moth damage of crops.

The composition of the invention may also be used to disrupt Tortrix moth mating behaviour, host-finding behaviour and/or egg-deposition behaviour. Pheromone-based mating disruption have previously been used for the management of other moths, such as the internal fruit-feeding codling moth, Cydia pomonella. Similar methods may be used with Tortrix moth species, e.g. by using composition of the invention to disrupt mating behaviour or host-finding behaviour of the Tortrix moth, and/or the egg-deposition behaviour of a female Tortrix moth. Similar results may be obtained by broadcasting combinations of pheromone and attractive host-plant kairomones (e.g. compositions of the invention). Given that such kairomones are attractive by themselves (often to both sexes), and also that they may enhance male moth response to their pheromone, it is possible that the effects of competitive attraction and potentially other mechanisms of disruption might be increased.

The invention therefore provides a method of disrupting Tortrix moth mating or host-finding behaviour of the Tortrix moth and/or egg-deposition behaviour of a female Tortrix moth in a location, comprising:
(i) placing a composition of the invention in the location.

Optionally, the composition of the invention additionally comprises a pheromone which is attractive to Tortrix moths, e.g. (E,E)-8,10-dodecadien-1-yl acetate (E8E10-12AC).

In some embodiments, the invention also provides a method of trapping and/or controlling Tortrix moths, the method comprising the steps:
(i) placing a composition or insect trap comprising (E)-β-ocimene and/or (Z)-β-ocimene in a location which is inhabited or thought to be inhabited by the Tortrix moths.

The invention also provides the use of a composition or insect trap comprising (E)-β-ocimene and/or (Z)-β-ocimene for trapping and/or controlling Tortrix moths.

### BRIEF DESCRIPTION OF THE FIGURES

FIG. 1. Antennal response of mated female C. nigricana to synthetic analogues of pea flower volatiles, presented as dose response by means of GC-EAD to nine compounds at four doses (n=3-5 moth per compound and dose, respectively). Comparison among the dose rates were marked with lowercase letters (ANOVA, Tukey, p<0.05).

FIG. 2. Behavioural response of mated female C. nigricana to blends of the synthetic analogues of pea flower volatiles (stimulus I-VIII), released by a sprayer in the wind tunnel. The response is presented as proportion (±SE) landing of pea moth at the odour source. Comparison among the odour stimuli I-VIII were marked with lowercase letters (ANOVA, Tukey, p<0.05).

FIG. 3. Behavioural response of mated female C. nigricana to headspace extract of pea plants during leave development (stimulus IX) and the same headspace extract spiked with blends of four selected synthetic pea flower volatiles (1-hexanol, (E)-2-hexen-1-ol, (E)-β-ocimene, (Z)-β-ocimene) (stimulus X-XII), released by a sprayer in the wind tunnel. The response is presented as proportion (±SE) landing of pea moth at the odour source. Comparison among the odour stimuli IX-XII were marked with lowercase letters (ANOVA, Tukey, p<0.05).

FIG. 4. Behavioural response of mated female C. nigricana to a blend of four selected synthetic pea flower volatiles (1-hexanol, (E)-2-hexen-1-ol, (E)-β-ocimene, (Z)-β-ocimene), using four doses (stimulus XIII-XVI) and released by a sprayer in the wind tunnel. Stimulus XIV is mimicking the mean release rates from pea flowers for each of the four compounds. The other three doses (XIII, XV, XVI) are a multiple of stimulus XIV (one-tenth, threefold, tenfold, respectively). The response is presented as proportion (±SE) landing of pea moth at the odour source. Comparison among the odour stimuli XIII-XVI were marked with lowercase letters (ANOVA, Tukey, p<0.05).

FIG. 5. Attraction of C. nigricana (male, female) to blends of synthetic analogues of pea flower volatiles (stimuli I, II, IV, V), formulated in mineral oil on cotton wicks in microtubes as dispensers in delta traps in two exemplary pea fields in Norway. All blends had a total load of 9 mg active ingredients per dispenser. The control stimuli contains mineral oil only. The attraction is presented as number of trapped moths per trap during the flower period (mean±SE, n=6). Comparison among the odour dispensers I-V were marked with lowercase letters (ANOVA, Tukey, p<0.05).

FIG. 6. Behavioural responses of mated C. nigricana females to headspace extract of flowering sweet pea (I_{WT}) and blends of synthetic sweet pea flower volatiles (stimuli II_{WT}-VI_{WT}) tested in released by a sprayer in a wind tunnel. The responses are presented as the proportion (±SE) of landings of the moths on the odour source.

Table 3: Significant differences are indicated by the lower case letters (ANOVA, Tukey, p<0.05).
stimuli II_{WT}: all antennally active sweet pea flower volatiles
stimuli III_{WT}: volatiles which are present in both, flowering sweet pea and pea
stimuli IV_{WT}: volatiles which are present only in flowering sweet pea and not in pea
stimuli V_{WT}: volatiles which are present only in flowering sweet pea+the four previously identified key-compounds from pea flowers
stimuli VI_{WT}: volatiles which are present only in sweet pea+(Z)- and (E)-ocimene

FIG. 7. Trap captures (mean±SE, n=4) of C. nigricana males and females responding to flowers of sweet pea (I_{F}) and to blends of synthetic sweet pea flower volatiles (stimuli II_{F}, III_{F}, IV_{F}, and VI_{F}). Significant differences are indicated by the lower case letters (ANOVA, Tukey, p<0.05).

Table 4: stimuli II_{F}: all antennally active sweet pea flower volatiles
stimuli III_{F}: volatiles which are present in both, flowering sweet pea and pea
stimuli IV_{F}: volatiles which are present only in flowering sweet pea and not in pea
stimuli VI_{F}: volatiles which are present only in sweet pea+(Z)- and (E)-ocimene

### EXAMPLES

The present invention is further illustrated by the following Examples, in which parts and percentages are by weight and degrees are Celsius, unless otherwise stated. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various usages and conditions. Thus, various modifications of the invention in addition to those shown and described herein will be apparent to those skilled in the art from the foregoing description. Such modifications are also intended to fall within the scope of the appended claims.

The disclosure of each reference set forth herein is incorporated herein by reference in its entirety.

### Example 1

### Materials and Methods

### Insects

C. nigricana were collected as larvae in the North of Hesse, Germany. The keeping of the insects followed the protocol of Thöming and Saucke (2011). Emerging adults mated in Plexiglas cages (30×30×30 cm) in a climate chamber (18±2° C., 60-70% RH, 18:6h L:D). The moths were provided with 10%-honey water solution and water until the experiment. Antennal recordings and wind tunnel tests were done with five-to-seven-days old mated females. After the experiments, females were dissected to verify their mating status and only mated females were used for analysis.

### Artificial Pea Flower Volatiles

The synthetic odour sources were prepared to mimic natural pea flower odour. The quantity, ratio and blend composition was based on the identification and quantification of compounds emitted from detached pea flowers (50 flowers/headspace sample; mean value, n=10) of P. sativum (cv. AVOLA). The synthetic analogues of all 28 identified compounds released from pea plant material (Table 1) were used for combined gas chromatography-electroantennal detection (GC-EAD) analysis.

The synthetic analogues of the nine compounds which I) were emitted from detached pea flowers and, II) caused antennal responses in mated females of C. nigricans using headspace samples of pea plant material (Table 1), were selected for the behavioural experiments in this study.

### Statistics

The moth responses (percentage landings in the wind tunnel, number trap catches in the field) were subjected to Levene test to evaluate for variance homogeneity and then normalized using arcsine-square-root or rather log-transformation transformation if necessary. Differences among treatments were assessed by analysis of variance (ANOVA). If significant F-values were obtained, treatment means were compared using Tukey's test (Sokal and Rohlf, 1995). Differences between responses towards pure synthetic blends (Experiment 1) and the corresponding blend added to headspace extracts of pea plants during leaf development (Experiment 2) were analysed with the Kruskal-Wallis test for pair wise comparison (Montgomery, 2001). A significance level of α=0.05 were selected in all analyses using SAS 9.2 (SAS Institute Inc., Cary, N.C., US).

### Example 2

### Electro-Antennography

GC-EAD was used for antennal recordings on a HP 6890N gas chromatograph, equipped with an HP-5 (30 m×320 μm×0.25 μm; Agilent, Santa Clara, Calif., US) capillary GC column, programmed from 40° C. (hold for 0.5 min) at 8° C./min to 160° C., then 25° C./min to 230° C. (hold for 4 min), and coupled with an electro-antennogram apparatus (Syntech, Hilversum, The Netherlands). The outlet of the GC column was split in a 1:1 ratio between the flame ionization detector (FID) and a pair of cut pea moth antennae which was connected to the EAD. The antennae were mounted in a holder (Syntech) between two silver electrodes, using electrically conductive Gel (Parker, Fairfield, N.J., US). The EAD capillary effluent was delivered to the antennae through a heated transfer line (Syntech) in a glass tube (12 cm×8 mm) in which humidified air was flowing through. The antennal signal and the FID signal were amplified and recorded simultaneously using Syntech software. Each sample injected on the GC contained 5-9 synthetic compounds with different retention times. Each compound was injected at four doses (200 ng, 60 ng, 20 ng, 6 ng), equivalent to 100 ng, 30 ng, 10 ng, 3 ng tested on the antennae. The antennal responses towards compounds and dose rates, respectively, were replicated three to five times, always using a new pair of antennae. The antennal condition was tested before and after the treatment with odour puffs of 10 ml/sec. during 0.2 sec from a Pasteur pipette containing 10 μg 4,8-dimethyl-1, (E) 3,7-nonatriene (DMNT) in 10 μl hexane and applied onto filter paper (0.5×1.0 cm), since this compound showed reproducible antennal responses. Only antennae with differences less than 5 μV between the puff before and after the treatment were used for analysis.

### Results

TABLE 1
Synthetic analogues of pea volatiles used for electro-antennograhic
recordings and selection of compounds for behavioural experiments
in laboratory and field.

| Pea plant | | | Pea flower | EAG active |
|---|---|---|---|---|
| compound^{a} | CAS RN | Source^{b} | compound^{c} | using HSₚₑₐ^{d} |
| Undecane | 1120214 | 1 | | |
| 2,7,10- | 74645980 | 2 | | |
| trimethyldodecane | | | | |
| (Z)-3-hexenal | 6789806 | 2 | | |
| 2-(E)-hexenal | 6728263 | 3 | | |
| hexanal | 66251 | 4 | | |
| octanal | 124130 | 4 | | |
| nonanal | 124196 | 4 | | |
| decanal | 112312 | 3 | | |
| 3-hexanone | 565695 | 3 | | |
| 2-hexen-4-olide | 2407434 | 2 | | |
| 1-hexanol | 111273 | 5 | | |
| (Z)-3-hexenol | 928961 | 5 | | |
| 3-hexanol | 623370 | 3 | | |
| (E)-3-hexen-1-ol | 928972 | 3 | | |
| (E)-2-hexen-1-ol | 928950 | 3 | | |
| 2-ethyl-1-hexanol | 104767 | 3 | | |
| (Z)-3-hexenyl | 3681718 | 3 | | |
| acetate | | | | |
| hexyl acetate | 142927 | 5 | | |
| 2-hexen-1-ol, | 2497189 | 3 | | |
| acetate, (E) | | | | |
| methyl salicylate | 119368 | 5 | | |
| toluene | 108883 | 6 | | |
| benzaldehyde | 100527 | 4 | | |
| (Z)-β-ocimene | 13877913^{e} | 3 | | |
| (E)-β-ocimene | 13877913^{e} | 3 | | |
| α-pinene | 80568 | 2 | | |
| β-caryophyllene | 87445 | 3 | | |
| 6-methyl-5-hepten- | 110930 | 3 | | |
| 2-one | | | | |
| γ-caprolactone | 695067 | 4 | | |

^{a}Synthetic analogues of pea plant volatiles identified in headspace extracts from pea plants material at different phenological stages in previous studies, and used for EAG recordings in this study.
^{b}1) Supleco, 2) Yngve H. Stenstrøom, 3) Aldrich, 4) Chiron AS, 5) Fluka, 6) Lab-Scan.
^{c}Volatiles found in detached pea flowers (50 flowers per headspace sample).
^{d}Volatile compound induced antennal activity in female pea moth when headspace extracts of pea plant material (HSₚₑₐ) were used for GC-EAD.
^{e}Synthetic standards of (Z)- and (E)-β-ocimene were used as mix of isomers.

TABLE 2

| | | Kovats | Pea plants at phenological stage | | | | | | | | | | Flowers | |
|---|---|---|---|---|---|---|---|---|---|---|---|---|---|---|
| | | index | Leaf^{b} | | Bud^{c} | | Flower^{d} | | Pod^{e} | | Buds only^{f} | | only^{g} | |
| Compound^{a} | CAS # | DB-Wax | % | ±SE | % | ±SE | % | ±SE | % | ±SE | % | ±SE | % | ±SE |

Aliphatics

| | | | | | | | | | | | | | | | |
|---|---|---|---|---|---|---|---|---|---|---|---|---|---|---|---|
| Alkanes | undecane | 1120214 | 1100 | 0.002 | 0.001 | TR^{h} | | 0.008 | 0.006 | | | 0.021 | 0.018 | 0.013 | 0.002 |
| | 2,7,10- | 74645980 | 1436 | | | | | | | | | | | 0.006 | 0.002 |
| | trimethyldodecaneⁱ | | | | | | | | | | | | | | |
| Aldehydes | (Z)-3-hexenal | 6789806 | 1132 | 0.005 | 0.003 | 0.269 | 0.080 | 0.155 | 0.042 | 0.024 | 0.012 | | | | |
| | (E)-2-hexenal | 6728263 | 1189 | 0.006 | 0.003 | 0.152 | 0.042 | 0.093 | 0.024 | 0.012 | 0.005 | 0.061 | 0.014 | 0.030 | 0.004 |
| | hexanal | 66251 | 1066 | | | 0.063 | 0.018 | 0.044 | 0.010 | 0.009 | 0.003 | 0.027 | 0.004 | 0.016 | 0.002 |
| | octanal | 124130 | 1279 | 0.023 | 0.006 | 0.007 | 0.002 | 0.004 | 0.001 | 0.002 | 0.001 | 0.001 | 0.001 | 0.002 | 0.001 |
| | nonanal | 124196 | 1383 | 0.066 | 0.014 | 0.019 | 0.004 | 0.015 | 0.002 | 0.005 | 0.002 | 0.019 | 0.003 | 0.013 | 0.002 |
| | decanal | 112312 | 1488 | 0.065 | 0.013 | 0.016 | 0.003 | 0.014 | 0.003 | 0.003 | 0.001 | 0.015 | 0.003 | 0.010 | 0.002 |
| Ketones | 3-hexanone | 598383 | 929 | 0.031 | 0.004 | 0.002 | 0.001 | TR | | 0.001 | 0.001 | | | 0.001 | 0.001 |
| | unknown | | 1561 | | | 0.035 | 0.008 | 0.014 | 0.004 | 0.003 | 0.002 | | | | |
| Alcohols | 1-hexanol | 111273 | 1349 | 0.065 | 0.026 | 0.199 | 0.055 | 0.163 | 0.045 | 0.015 | 0.006 | 0.159 | 0.037 | 0.091 | 0.016 |
| | (Z)-3-hexenol | 928961 | 1376 | 1.592 | 0.547 | 2.659 | 0.584 | 1.659 | 0.433 | 0.274 | 0.111 | 0.503 | 0.123 | 0.145 | 0.025 |
| | 3-hexanol | 623370 | 1176 | 0.031 | 0.003 | 0.005 | 0.003 | 0.004 | 0.002 | 0.001 | 0.001 | 0.002 | 0.001 | 0.002 | 0.001 |
| | (E)-3-hexen-1-ol | 928972 | 1336 | 0.262 | 0.170 | 0.080 | 0.068 | 0.007 | 0.002 | 0.070 | 0.046 | 0.218 | 0.212 | 0.283 | 0.141 |
| | (E)-2-hexen-1-ol | 928950 | 1377 | 0.013 | 0.004 | 0.032 | 0.009 | 0.026 | 0.007 | 0.001 | 0.001 | 0.076 | 0.024 | 0.032 | 0.004 |
| | 2-ethyl-1-hexanol | 104767 | 1487 | 0.040 | 0.008 | 0.035 | 0.013 | 0.020 | 0.005 | 0.010 | 0.004 | 0.014 | 0.003 | 0.012 | 0.005 |
| Esters | (Z)-3-hexenyl acetate | 3681718 | 1307 | 3.061 | 0.880 | 7.467 | 1.637 | 5.074 | 1.083 | 0.482 | 0.195 | 4.379 | 0.728 | 0.705 | 0.132 |
| | hexyl acetate | 142927 | 1263 | | | 0.127 | 0.032 | 0.107 | 0.023 | 0.019 | 0.005 | 0.281 | 0.054 | 0.089 | 0.016 |
| | 2-hexen-1-ol, | 2497189 | 1308 | 0.025 | 0.005 | 0.024 | 0.006 | 0.018 | 0.005 | 0.001 | 0.001 | 0.060 | 0.015 | 0.013 | 0.003 |
| | acetate, (E) | | | | | | | | | | | | | | |

Benzenoids and phenylpropanoids

| | | | | | | | | | | | | | | | |
|---|---|---|---|---|---|---|---|---|---|---|---|---|---|---|---|
| Esters | methyl salicylate | 119368 | 1762 | 0.456 | 0.311 | 0.131 | 0.130 | 0.004 | 0.001 | | | 0.480 | 0.317 | 0.021 | 0.006 |
| Hydrocarbons | toluene | 108883 | 1013 | | | TR | | | | 0.001 | 0.001 | 0.001 | 0.001 | | |
| Aldehydes | benzaldehyde | 100527 | 1508 | 0.004 | 0.002 | 0.001 | 0.001 | TR | | 0.001 | 0.001 | 0.001 | 0.001 | TR | |

Monoterpene

| | | | | | | | | | | | | | | | |
|---|---|---|---|---|---|---|---|---|---|---|---|---|---|---|---|
| Hydrocarbons | (Z)-β-ocimene | 3338554 | 1213 | 0.002 | 0.001 | TR | | 0.012 | 0.006 | | | 0.003 | 0.001 | 0.068 | 0.019 |
| | (E)-β-ocimene | 3779611 | 1247 | 0.025 | 0.005 | 0.014 | 0.003 | 0.144 | 0.058 | 0.006 | 0.001 | 0.026 | 0.006 | 0.535 | 0.152 |
| | α-pinene | 80568 | 1013 | | | TR | | TR | | | | | | TR | |

Sesquiterpenes

| | | | | | | | | | | | | | | | |
|---|---|---|---|---|---|---|---|---|---|---|---|---|---|---|---|
| Hydrocarbons | β-caryophyllene | 87445 | 1584 | 0.022 | 0.004 | 0.016 | 0.004 | 0.021 | 0.003 | 0.002 | 0.001 | 0.024 | 0.006 | 0.009 | 0.003 |

Irregular Terpenes

| | | | | | | | | |
|---|---|---|---|---|---|---|---|---|
| Ketones | 6-methyl-5-hepten- | 110930 | 1326 | TR | TR | TR | TR | TR |
| | 2-one | | | | | | | |

Miscellaneous cyclic compounds

| | | | | | | | | | | | | | | | |
|---|---|---|---|---|---|---|---|---|---|---|---|---|---|---|---|
| Esters | γ-caprolactone | 695067 | 1688 | 0.015 | 0.005 | 0.016 | 0.003 | 0.007 | 0.002 | 0.002 | 0.001 | 0.002 | 0.002 | 0.001 | 0.001 |

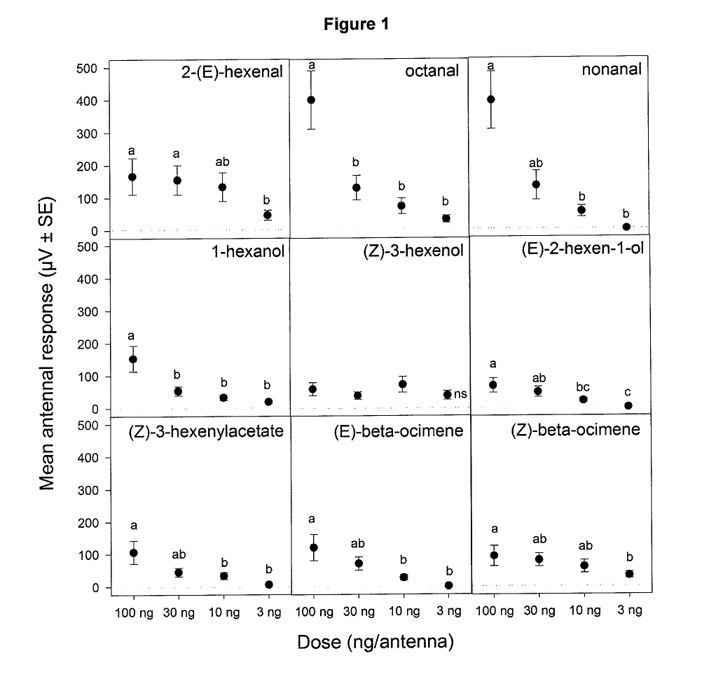

Out of the 28 synthetic compounds tested for electro-antennography dose-dependent responses, all nine synthetic analogues of the compounds which were found in detached pea flowers and induced antennal activity in C. nigricana using natural pea odour samples (Table 1) elicited antennal responses (FIG. 1). All these compounds, expect for (Z)-3-hexenol, showed a significant increase of antennal response with dose effect (see FIG. 1):

2-(E)-hexenal: F=6.26; df=3, 9; P=0.0139;
octanal: F=21.25; df=3, 10; P<0.0001;
nonanal: F=7.97; df=3, 9; P=0.0067;
1-hexanol: F=21.93; df=3, 8; P=0.0003;
(Z)-3-hexenol: F=0.55; df=3, 9; P=0.6578;
(E)-2-hexen-1-ol: F=9.67; df=3, 8; P=0.0049,
(Z)-3-hexenyl acetate: F=7.22; df=3, 9; P=0.0091;
(E)-β-ocimene: F=8.67; df=3, 9; P=0.0051;
(Z)-β-ocimene: F=5.06; df=3, 9; P=0.0252.

The residual 19 compounds showed no antennal response to any of the four tested dose rates or towards the high doses only (100 ng, 30 ng). Thus, the pre-selection of the nine flower specific and antennal active compounds was verified by the electro-antennography recordings testing the synthetic analogues of pea volatiles. Dose-dependent antennal responses indicated in general a graduated sensitivity of the antennal olfactory system of C. nigricana towards the nine pre-selected compounds. Thus, these nine artificial pea flower volatiles fulfil the qualifications to cause behavioural response in mated females of C. nigricana and this supported their use in the behavioural studies.

### Example 3

### Wind Tunnel

Female attraction to synthetic pea flower blends was tested in a wind tunnel (flight section 67×88×200 cm; Aak et al. 2010). Filtered air was blown at 30 cm/sec through the wind tunnel. The light intensity inside the tunnel was around 1000 lux, the room was kept at 20±2° C. and 60-70% RH. The odour stimuli were released from the centre of the upwind end of the wind tunnel using an ultrasonic sprayer with a conical nozzle (Sono-Tek corporation, Milton, N.Y., US). The tip of the nozzle was covered by a glass cylinder (10 cm diameter and 8 cm long) and a metal mesh. The glass cylinder and a spiral metal stick (45×0.5 cm) which was placed on the floor in the centre of the upwind end of the flight section, directly in front of the glass cylinder, were defined as landing area for the moths. The synthetic compounds were solved and mixed in hexane and then diluted with pure ethanol for the release in the wind tunnel at 10 μl/min. Females were placed individually in glass tubes (12.5×2.6 cm) and transferred to the wind tunnel room three hours before the start of the experiments. The wind tunnel tests were performed one to five hours before the scotophase. A tube with a moth was deposited at the centre of the downwind end of the tunnel and 160 cm from the odour source. The female was given 6 min to respond. The flight behaviour of C. nigricana was observed and the landing of the moth on odour source was recorded. For all tested stimuli a minimum of 50 mated females were examined, using five batches of ten females each and 30 to 60 moths per experimental day.

### Experiment 1

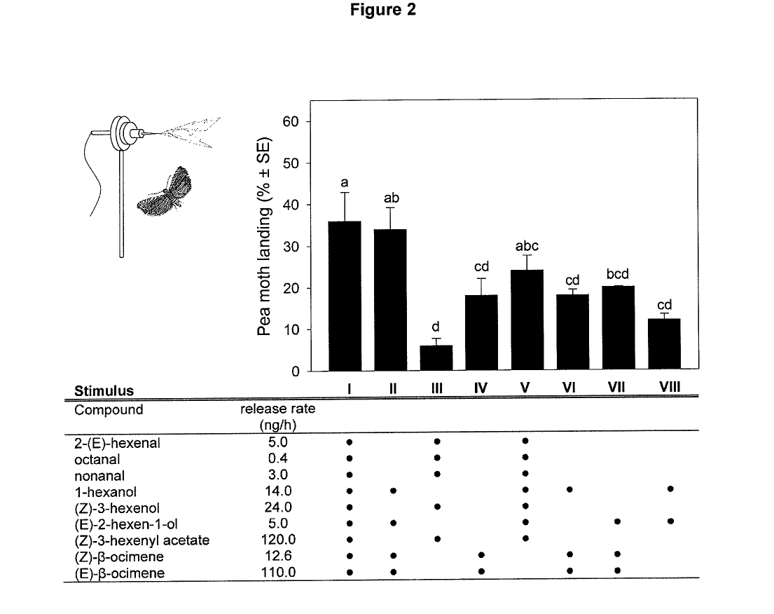

As odour sources in the first wind tunnel experiment, the synthetic analogues of the nine pea flower specific volatile compounds which induced antennal activity in C. nigricana using natural pea odour samples (Table 1) were tested. The compounds 2-(E)-hexenal, octanal, nonanal, 1-hexanol, (Z)-3-hexenol, (E)-2-hexen-1-ol, (Z)-3-hexenyl acetate, (E)-β-ocimene and (Z)-β-ocimene were tested in eight different blends (stimulus 1-VIII) and released in quantity and ratios according to volatile release from detached pea flowers (Table 2) as it is shown in FIG. 2. The blend with the highest attraction and lowest number of compounds was selected for further wind tunnel tests (stimulus II).

### Experiment 2

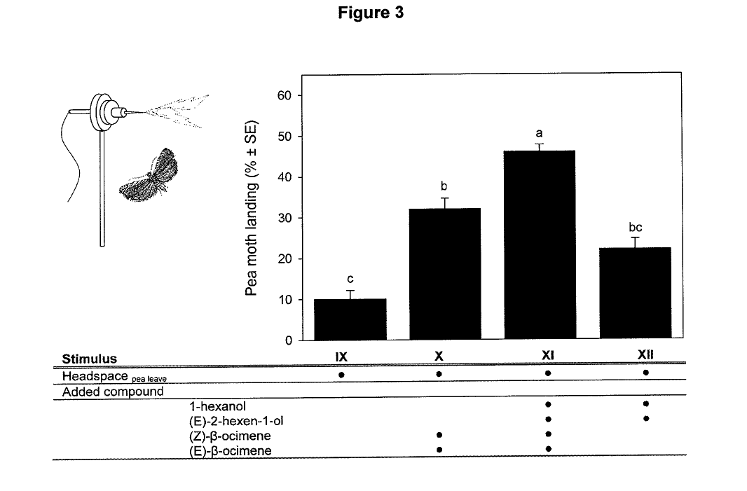

To assess the background odour context in female attraction towards synthetic pea flower volatiles, the compounds of the blend selected in the first experiment (stimulus II) were added to headspace extract of pea plants during leaf development and tested as odour stimuli in wind tunnel experiment 2. The release rate of each selected compound was corresponding to experiment 1. Details of the identification and quantification of compounds emitted from pea plants during leaf development (P. sativum, cv. AVOLA) are shown in Table 2. The pea leave headspace extract was tested pure and spiked with three different blends of the four pre-selected compounds 1-hexanol, (E)-2-hexen-1-ol, (E)-β-ocimene and (Z)-β-ocimene. The four tested stimuli (stimulus IX-XII) are presented in FIG. 3.

### Experiment 3

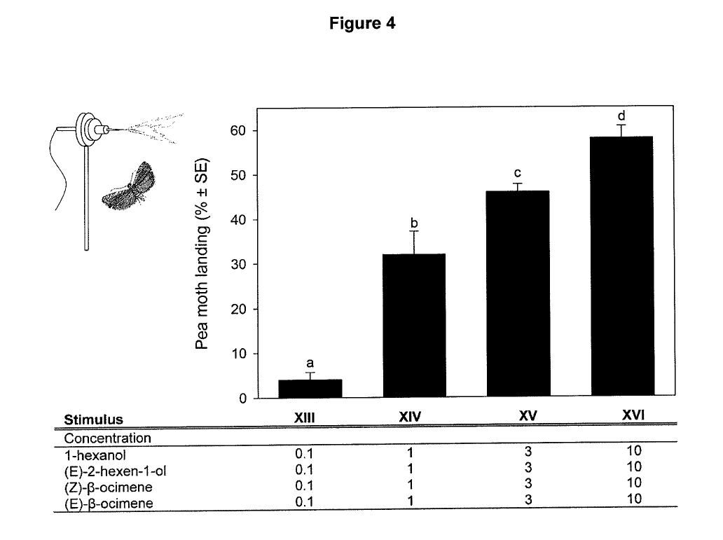

The dose-response relationship between the selected artificial pea flower blend (stimulus II) and the attraction of mated female pea moth was studied in a third wind tunnel test. The pre-selected blend of the compounds 1-hexanol, (E)-2-hexen-1-ol, (E)-β-ocimene and (Z)-β-ocimene, presented in quantity and ratio as emitted from natural pea flowers like in the previous experiments, provided the basis for the behavioural dose-response test. Four doses were tested: the pure blend (Concentration 1=stimulus XIV=stimulus II), a 1:10 diluted blend (Concentration 0.1=stimulus XIII), a 1:3 concentrated blend (Concentration 3=stimulus XV) and a 1:10 concentrated blend (Concentration 10=stimulus XVI) (FIG. 4).

### Results

The behavioural response of mated females of C. nigricana to synthetic pea flower volatiles in the wind tunnel is shown in FIG. 2-4. In the first experiment, a “pea flower mimic” was composed of the nine synthetic pea flower volatiles (stimulus I), using pea flower specific quantities and ratios (Table 1, FIG. 2). This pea flower mimic blend caused high attraction of mated females in the wind tunnel with mean landings of 36% (FIG. 2). Similar attraction with 34% landing was shown to the four-compound blend (stimulus II) (F=11.09; df=4, 20; P=0.9950; FIG. 2), whereas the blend of the remaining five pea flower compounds (stimulus III) resulted in significant lower attraction with 6% landing only (F=11.09; df=4, 20; P=0.0001; FIG. 2). The mix of the β-ocimene isomeres (stimulus IV) resulted in a similar attraction (18% landing) to the pea flower mimic blend without β-ocimene (stimulus V, 24% landing) and the reduced blends of the four-compound blend (stimulus VI, 18% landing; stimulus VII, 20% landing; stimulus VIII, 12% landing) (FIG. 2).

In this wind tunnel test (Experiment 1), we tested synthetic analogues of pea flower volatiles which were emitted in outstanding high concentrations from flowering pea plants, detached buds and flowers (stimulus II) compared to omnipresent volatiles found in all phenological stages of pea plants and in many other plant species (stimulus III) (Jacobsen et al. 1998; Dudareva et al. 2006; Knudsen et al. 2006; and Table 2). The high attraction response towards the four-compound blend (stimulus II) emphasizes the importance of the flower specific release of 1-hexanol, (E)-2-hexen-1-ol, (E)-β-ocimene and (Z)β-ocimene as attractant for female C. nigricana compared to the rest of the tested omnipresent compounds (stimulus III). The results also show that other blends were efficacious.

The four-compound blend was as attractive for mated females of C. nigricana as the full pea flower mimic blend, even showing dose response in the wind tunnel with landings up to 58% in an additional wind tunnel experiment. Here, the pre-selected four-compound blend (stimulus II) was tested in a dose-response bioassay (FIG. 4). Testing four concentrations (stimulus XIII-XVI), a significant enhanced behavioural response of female C. nigricana was shown (F=67.12; df=3, 16; P<0.0001). Among these four flower-specific volatiles, (E)-β-ocimene and (Z)-β-ocimene acts as principal constituents causing already high attraction in the wind tunnel if presented as mix of isomere only (FIG. 2). Neither the pea flower mimic blend without β-ocimene nor one of the odour stimuli containing a reduced blend of 1-hexanol, (E)-2-hexen-1-ol and β-ocimene resulted in a higher attraction than the β-ocimene mix only. This shows that the two monoterpenes operated as fundamental compounds and blending (E)-β-ocimene and (Z)-β-ocimene with 1-hexanol and (E)-2-hexen-1-ol had a synergistic effect on female attraction.

As the blend with the highest attraction and the lowest number of compounds in the blend, the four-compound blend (stimulus II) was selected for further behavioural bioassays in this study.

Testing the pea moth attraction in the wind tunnel to pea flower synthetics combined with a pea background odour as released from host vegetation in the field provide a better understanding of the synergism and redundancy in the pea flower volatiles. To assess the background odour context in female attraction of C. nigricana towards synthetic pea flower volatiles, we tested the four compounds of the selected blend (stimulus II) added to headspace extract of pea plants during leaf development and tested these as odour stimuli in wind tunnel Experiment 2. The pure background odour (stimulus IX) resulted in 10% of landing females (FIG. 3). Significant higher attraction were recorded for pea plant headspace extract spiked with β-ocimene (stimulus X, 32% landing) and the headspace extract of pea plants spiked with the four compounds 1-hexanol, (E)-2-hexen-1-ol, (E)-β-ocimene and (Z)-β-ocimene (stimulus XI, 46% landing) (F=21.18; df=3, 16; P=0.0013, P<0.0001, respectively; FIG. 3). A clear background odour effect in pea moth host location was demonstrated. By adding the pea flower specific volatiles of the four-compound blend in different blends to headspace extracts of pea plants during leaf development and presenting these mixes as stimuli in the wind tunnel, we recorded for all tested blends higher attraction responses of C. nigricana if presented with pea leave background (FIG. 3) than without (FIG. 2) (β-ocimene: χ2=5.55, P=0.019; four-compound blend: χ2=5.4, P=0.02; four-compound blend without β-ocimene: χ2=3.72, P=0.054). In addition, adding the mix of (E)-β-ocimene and (Z)-β-ocimene or all four compounds to the pea leave background odour a significant higher attraction resulted than to the pure pea leave odour. These findings underlines the importance of background odour for host location of C. nigricana. At the same time, the results verified that the isomers of β-ocimene are fundamental volatile cue for pea moths' host location and 1-hexanol and (E)-2-hexen-1-ol had a strong synergistic effect on female attraction if mixed with β-ocimene.

Basing on the results of the overall wind tunnel experiments, the four odour stimuli I, II, IV and V were selected for a field experiment testing the behavioural response in the field.

### Example 4

### Field Experiment

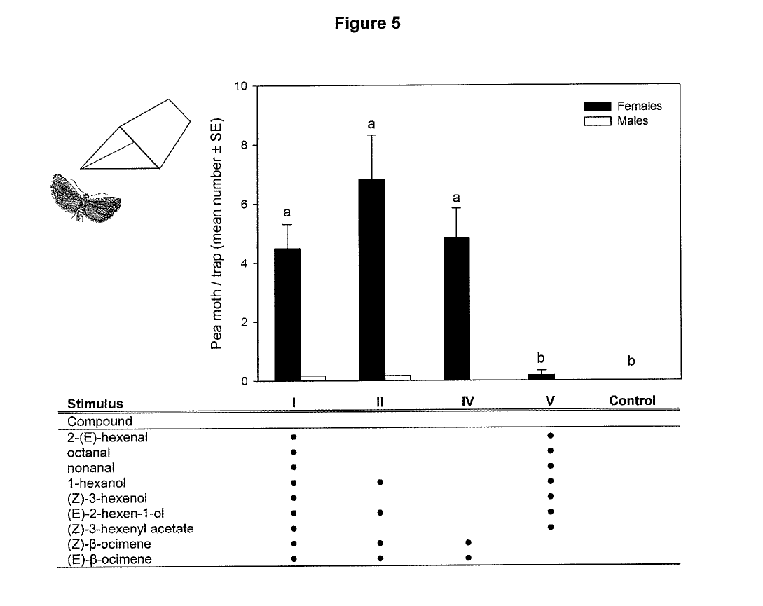

In parallel to the behavioural tests in the wind tunnel, the female attraction to synthetic pea flower mimics was tested in the field. This first preliminary field screening was established in exemplary pea fields of P. sativum at two locations in East of Norway, in Ås (59° 67′ N, 10° 77′ E; 0.6 ha, green pea, cv. AVOLA) and Våler (59° 48′ N, 10° 87′ E; 3.9 ha, grain pea, cv. FAUST) in 2012. The peas were sown on 2nd May, the first flower buds were visible 13th June in Ås, Norway, and 19th of June in Våler, the flower period started 17th June (Ås) and 25th of June (Våler). The synthetic compounds were mixed in mineral oil. All blends had a total load of 9 mg active ingredients per dispenser. The blends were diluted in 2 ml mineral oil and pipetted on dispensers consisting of cotton wicks (1 cm length; Parotisroll, Size 5; Roeko, Langenau, Germany), inserted in polypropylene microtubes (1.5 ml, Easy-Fit; Treff, Degersheim, Switzerland). The dispensers were mounted in cardboard delta traps equipped with yellow sticky bottoms (16.5×18×13 cm; Silvandersson Sweden, Knäred, Sweden). The traps were installed in the field using metal gibbets (1.2 m height, 0.8 cm in diameter). The traps were placed in the border area of the pea fields, 3 m from the field edge and 5 m in between traps at the beginning of the pea flower period in the respective field. The trapped moth were counted and sexed twice a week over a period of 5 weeks until the end of the flight period of C. nigricana end of July. Based on the results of the wind tunnel experiments, four odour stimuli (stimulus I, II, IV, V) and a blank control (pure mineral oil on the cotton wicks) were tested in the fields (FIG. 5). For each treatment three traps were installed per field.

### Results

As a counterpart of the behavioural wind tunnel test in the laboratory, the attraction of C. nigricana was tested using selected synthetic pea flower blends in a field screening. Pea moths were trapped in delta traps in two exemplary pea fields in Norway using synthetic blends of 9 mg total load active ingredients mixed in mineral oil and formulated on cotton wicks in polypropylene microtubes (FIG. 5). Similar numbers of females were attracted with the pea flower mimic blend (stimulus I, 4.5 females/trap, n=6), the four-compound blend (stimulus II, 6.8 females/trap, n=6) and the β-ocimene mix (stimulus IV, 4.8 females/trap, n=6), whereas significant lower numbers of moths were trapped with the pea flower mimic blend without β-ocimene (stimulus V, 0.17 females/trap, n=6) (F=11.75; df=4, 25; P<0.0001; FIG. 5). Only single males were attracted to stimulus I and II, and no males to stimulus IV and V; no moths were trapped in the control treatment (FIG. 5). In this field experiment, the key role of β-ocimene in host location of C. nigricana becomes apparent. Here, the synthetic pea flower volatiles were tested for pea moth attraction with the natural odour of a flowering pea field as background. Using β-ocimene as attractant resulted in similar trap catches than the full pea flower mimic and the four-compound blend, in contrast to our wind tunnel experiments where we showed significant lower attraction using β-ocimene only. A similar discrepancy in field and laboratory attraction of C. nigricana were shown for the synthetic pea flower mimic without β-ocimene, with a very low attraction in the field and high attraction in the wind tunnel compared to β-ocimene as attractant. This inconsistency in field and laboratory results demonstrates that interactions with the background odour contribute to the behavioural effect of synthetic host volatiles in the field (Knudsen et al. 2008). The synergistic effects of 1-hexanol and (E)-2-hexen-1-ol on the female attraction if presented as a blend with both isomers of β-ocimene we have shown in the wind tunnel experiments were not found in the field. Here, all other pea flower volatiles beside (E)-β-ocimene and (Z)-β-ocimene seems to be of less relevance, since attraction to the full pea flower mimic blend and the four-compound blend was not significantly different from the β-ocimene mix. However, for all tested stimuli in the field, the same total load of active ingredient per dispenser was used. Thus, the isomere mix of β-ocimene was presented with an eight times higher concentration than in the full pea flower mimic blend which might have had an effect on the results.

### Example 5

### Selecting a High-Flying Kairomone Mix for Pea Moth Females by Including Volatiles of Alternative Host Plants

### BACKGROUND

In this study, we proposed an approach to improve synthetic female attractants for pea moth Cydia nigricana Fabricius (Lepidoptera: Tortricidae) by combining attractive flower volatiles from the main host plant Pisum sativum (Fabaceae) with those of alternative host plants of the Fabaceae family. In insects with non-dispersive larval stages, like the pea moth, the host plant, i.e. the food source for the larvae, is selected by the females. By identifying odour compounds in headspace extracts of alternative host plants (here: Vicia fabae, Vicia sepium, Lathyrus odoratus tested), we were aiming to compare female attraction to synthetic volatiles from an alternative host plant with the cues emitted by cultivated peas, P. sativum. With this approach, we were aiming for the identification of volatile cues which are highly attractive for pea moth but not included in the odour profile of cultivated peas.

### Summary of the Results

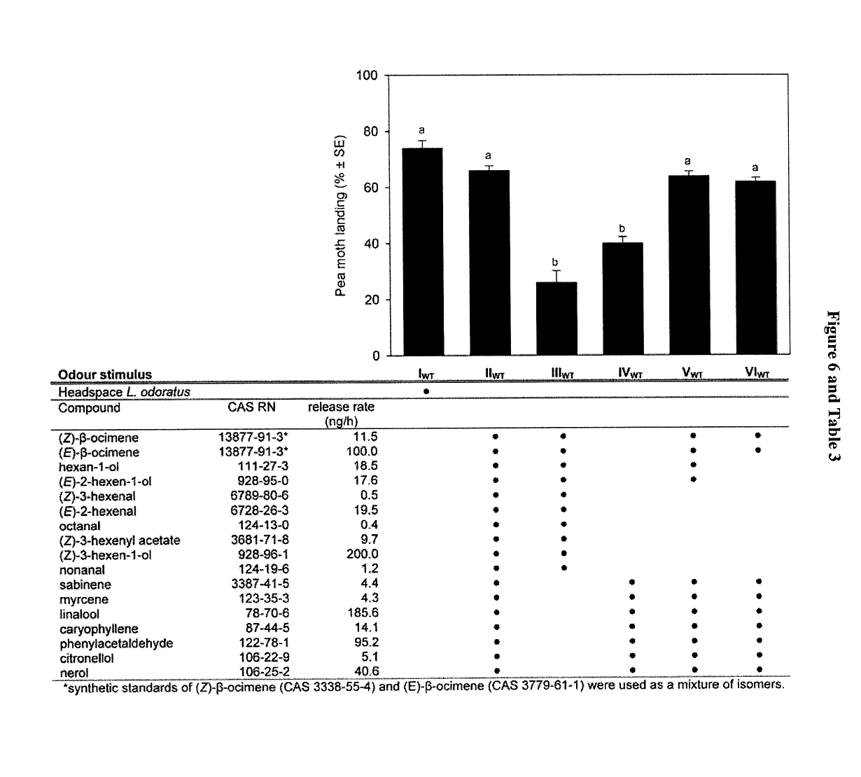

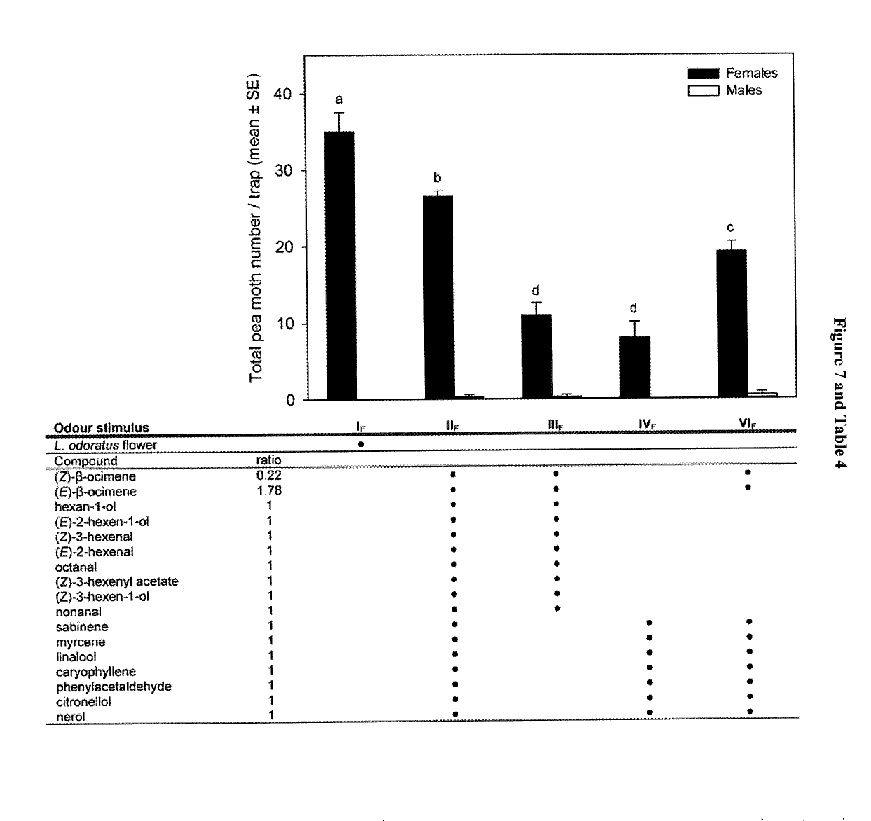

The sweet pea Lathyrus odoratus (cv. Old Spice) was highly attractive for pea moth females. After volatile collections and chemical analyses, the antennally active compounds were identified and tested as synthetics in different blends in the wind tunnel (FIG. 6: quantity and ratio were based on the identification and quantification of compounds emitted from flowering sweet pea plant (mean value, n=6) of L. odoratus (cv. Old Spice)) and in the field (FIG. 7: (Z)- and (E)-ocimene were used as a mixture of isomers with a ratio of 1:8, the Z:E ratio of all blends used in the fields was 0.22:1.78, whereas all other synthetic compounds were present at a 1:1 ratio and the total load of active ingredients in each dispenser was always 9 mg). Materials and methods were as given in the above Examples.

### REFERENCES

Aak, A., Knudsen, G. K. and Soleng, A. 2010. Wind tunnel behavioural response and field trapping of the blowfly Calliphora vicina. Medical and Veterinary Entomology 24: 250-257.
Dudareva, N., Negre, F., Nagegowda, D. A., Orlova, I. 2006. Plant volatiles: recent advances and future perspectives. Critical Reviews in Plant Sciences 25: 417-440.
Jakobsen H. B., Hansen, M., Christensen, M. R., Brockhoff, P. B., and Olsen, C. E. 1998. Aroma volatiles of blanched green peas (Pisum sativum L.). J. Agric. Food Chem. 46: 3727-3734.
Knudsen J. T., Eriksson, R., and Gershenzon, J. 2006. Diversity and distribution of floral scent. Bot. Rev. 72: 1-120.
KNUDSEN, G. K., BENGTSSON, M., KOBRO, S., JAASTAD, G., HOFSVANG, T., and WITZGALL, P. 2008. Discrepancy in laboratory and field attraction of apple fruit moth Argyresthia conjugella to host plant volatiles. Physiol. Entomol. 33: 1-6.
Montegomery, D. C. 2001. Design and Analysis of Experiments. John Wiley & Sons, Inc., New York
SOKAL, R. R. and ROHLF, F. J. 1995. Biometry: The principles and practice of statistics in biological research. W. H. Freeman, New York.
Thöming, G. and Saucke, H. 2011. Key factors affecting the spring emergence of pea moth (Cydia nigricana). Bulletin of Entomological Research. 101: 127-133.

1. A method of trapping and/or controlling pea moths, the method comprising the step:
(i) placing an insect trap in a location which is inhabited or thought to be inhabited by pea moths,
wherein the insect trap contains a composition comprising:
(a) (E)-β-ocimene,
(b) (Z)-β-ocimene,
(c) 1-hexanol and
(d) (E)-2-hexen-1-ol.

2. A composition for attracting Tortrix moths, wherein the composition comprises:
(a) (E)-β-ocimene,
(b) (Z)-β-ocimene,
(c) 1-hexanol and
(d) (E)-2-hexen-1-ol.

3. A composition as claimed in claim 2, wherein the composition additionally comprises one or more compounds selected from the group consisting of:
(e) (Z)-3-hexenal,
(f) (E)-2-hexenal,
(g) octanal,
(h) nonanal,
(i) (Z)-3-hexenol and
(j) (Z)-3-hexenyl acetate.

4. A composition as claimed in claim 2 or claim 3, wherein the composition additionally comprises one or more pea moth pheromones, preferably (E,E)-8,10-dodecadien-1-yl acetate.

5. A composition as claimed in any one of claims 2 to 4, wherein the composition additionally comprises an insecticide.

6. A composition as claimed in any one of claims 2 to 5, wherein the composition additionally comprises one or more emulsifiers, antioxidants, thickeners, fillers, solvents and/or carriers.

7. An insect trap for trapping or controlling Tortix moths, wherein the insect trap comprises a composition as claimed in any one of claims 2 to 6.

8. A cartridge or module for an insect trap for trapping or controlling Tortix moths, wherein the cartridge or module comprises a composition as claimed in any one of claims 2 to 6.

9. A method of monitoring, annihilating, disrupting, trapping and/or controlling Tortrix moths, the method comprising the steps:
(i) placing a composition or an insect trap comprising the composition in a location which is inhabited or thought to be inhabited by Tortrix moths, wherein the composition comprises:
(a) (E)-β-ocimene, and
(b) (Z)-β-ocimene
and optionally
(ii) monitoring the number of Tortrix moths which are attracted to the composition or caught in the trap.

10. A method as claimed in claim 9, wherein the composition is as defined in any one of claims 2 to 6.

11. Use of a composition as defined in any one of claims 2 to 6, in attracting, monitoring, disrupting, annihilating, trapping or controlling Tortrix moths.

12. A kit for use as a Tortrix moth attractant or for use in an insect trap, the kit comprising:
(a) (E)-β-ocimene,
(b) (Z)-β-ocimene,
(c) 1-hexanol and
(d) (E)-2-hexen-1-ol;
and preferably one or more of:
(e) (Z)-3-hexenal,
(f) (E)-2-hexenal,
(g) octanal,
(h) nonanal,
(i) (Z)-3-hexenol and
(j) (Z)-3-hexenyl acetate.

13. A composition as claimed in any one of claims 2 to 6, an insect trap as claimed in claim 7, a cartridge or module as claimed in claim 8, a method as claimed in claim 9 or claim 10, a use as claimed in claim 11 or a kit as claimed in claim 12, wherein the Tortrix moth is a pea moth (Cydia nigricana), preferably a female pea moth.
